(19) United States
(12) Patent Application Publication
(10) Pub. No.: US 2025/0207767 A1
(43) Pub. Date: Jun. 26, 2025

(54) Christmas Wire Mount Device

(71) Applicant: Lester Jandreau, Mapleton, ME (US)

(72) Inventor: Lester Jandreau, Mapleton, ME (US)

(21) Appl. No.: 18/672,577

(22) Filed: May 23, 2024

Related U.S. Application Data
(60) Provisional application No. 63/613,205, filed on Dec. 21, 2023.

(51) Int. Cl. F21V 21/088; F21W 121/00

(52) U.S. Cl. CPC F21V 21/0885; F21W 2121/004

(57) ABSTRACT

A holiday light mount device is disclosed that easily secures holiday lights to vinyl corners. The holiday light mount device comprises a body component that is configured in an angled shape that mirrors the shape of the corner it is attached to. Typically, the body component is an elongated rectangular member that measures approximately one inch in width. The body component is secured around the corner and then snapped in place via its folded-over ends which engage the edges of the corner. The wire of the lights is positioned under the body component when the device is applied, securely holding the holiday lights in place.

### CROSS-REFERENCE TO RELATED APPLICATION

The present application claims priority to, and the benefit of, U.S. Provisional Application No. 63/613,205, which was filed on Dec. 21, 2023, and is incorporated herein by reference in its entirety.

### FIELD OF THE INVENTION

The present invention relates generally to the field of holiday light mount devices. More specifically, the present invention relates to a mechanism for mounting exterior holiday lights to the vinyl corners of a home or building. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in holiday light mount devices. Generally, installing holiday lights on the exterior corners of vinyl siding can be difficult and labor-intensive. However, finding a method to securely hold the lights in place is hard, and conventional methods, such as staples or nails will damage the vinyl siding.

It is often desired to support or hang objects, such as holiday lights on an exterior surface of vinyl siding corners. However, the vertical surface makes it difficult for lights to be hung without the use of staples or nails. A means to hang holiday lights, as well as ornamental decorations, extension cords, cables or satellite television cords, etc., without damaging the vinyl siding is needed.

Accordingly, there is a demand for an improved holiday light mount device that allows a user to mount exterior holiday lights to the vinyl corners of a home or building without using staples or nails. More particularly, there is a demand for a holiday light mount device that allows the lights to be installed and removed without damaging the vinyl siding.

Therefore, there exists a long-felt need in the art for a holiday light mount device that provides users with a means for mounting exterior holiday lights to the vinyl corners of a home or building. There is also a long-felt need in the art for a holiday light mount device that enables users to secure the lights to the siding without the need for staples, hooks, nails, or other means. Further, there is a long-felt need in the art for a holiday light mount device that ensures that the lights can be installed and removed without damaging the vinyl siding. Moreover, there is a long-felt need in the art for a device that eases the task of decorating by making the process quick and frustration free. Further, there is a long-felt need in the art for a holiday light mount device that allows users to decorate areas that may conventionally be too difficult to access. Finally, there is a long-felt need in the art for a holiday light mount device that measures approximately one inch in width.

The subject matter disclosed and claimed herein, in one embodiment thereof, comprises a holiday light mount device. The device is a seasonal accessory designed to allow home and business owners to easily secure holiday light to viny corners. The holiday light mount device comprises a body component that is configured in an angled shape that mirrors the shape of the corner it is attached to. Typically, the body component is an elongated rectangular member that measures approximately one inch in width. The body component is secured around the corner and then snapped in place via its folded-over ends which engage the edges of the corner. The wire of the lights is positioned under the body component when the device is applied, securely holding the holiday lights in place. The device is typically manufactured of vinyl and is applied to the corners that project outwards from a building or the support beams.

In this manner, the holiday light mount device of the present invention accomplishes all of the foregoing objectives and provides users with a device that mounts holiday lights to vinyl corners without nails or staples. The device measures approximately one inch in width. The device can be manufactured of a plastic material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a holiday light mount device. The device is a seasonal accessory designed to allow home and business owners to easily secure holiday lights to vinyl corners. The holiday light mount device comprises a body component that is configured in an angled shape that mirrors the shape of the corner it is attached to. The body component is secured around the corner and then snapped in place via its folded-over ends. The strand of lights is positioned under the body component when the device is applied, securely holding the holiday lights in place between the body component and the corner.

In one embodiment, the holiday light mount device is a hanging mount positioned over the corners that project outwards from a building or home, or from a support beam, etc., or other suitable place as is known in the art. The holiday light mount device may be used, for example, to mount objects such as Christmas lights, ornamental decorations, extension cords, cables or satellite television cords, etc., without damaging the vinyl siding. Notably, the holiday light mount device is attached to and supported on vinyl corners without requiring holes to be formed in or adhesives to be applied to the vinyl corners. As described in detail below, the holiday light mount device is configured to be readily inserted over a strand of holiday lights or other objects and onto the corner of a building, mounting the holiday light strand in place.

In one embodiment, the holiday light mount device comprises a body component that is configured in an angled shape that mirrors the shape of the corner it is attached to. Specifically, the body component has an angled configuration that matches the angle of the outside corner to which it is to be attached. Preferably, for a standard 90-degree outside corner, the body component has an L-shaped configuration, with an angle of approximately ninety (90) degrees between the two sides of the L. However, if the outside corner has an angle that is different than ninety (90) degrees, the body component may be configured to match such an angle. The body component can be any suitable size and shape as is known in the art, depending on the shape and size of the corner it is to be attached to. Further, the body component can be available in multiple sizes to be used with corners of different sizes. Accordingly, the dimensions for the body component may be selected such that the device may be used with any siding corner known in the art.

In one embodiment, the body component is an elongated, one-piece rectangular member that measures approximately one inch in width but can be any suitable size as is known in the art. The elongated rectangular member is typically configured in an L-shape or angled shape to mirror the corner. The body component comprises an exterior surface which faces out from the corner and an interior surface which faces toward the corner. The body component also comprises top and bottom edges and opposing right and left ends.

In one embodiment, the opposing right and left ends of the body component comprise folded-over ends, such that the opposing ends fold-over on themselves. The folded-over ends are elastic and ductile, such that the ends retain their shape and are movable without breaking or fracturing. The folded-over ends do not contact an interior surface of the body component but leave room between the ends and the body component. Specifically, the opposing ends extend outwardly from the body component and fold-over on themselves, forming a curved lip or notch. In use, the body component is secured around the corner and then snapped in place via its folded-over ends which engage the edges of the corner. The folded-over ends secure to the corner via an interference fit between the folded-over ends and the edges of the corner. After use, the device can be easily removed via a user pulling open the folded-over ends, which releases the folded-over ends from the edges of the corner. Accordingly, the device can be secured and removed from the corner without use of nails, staples, or adhesives.

In use, a single strand of holiday lights is positioned on the surface of the corner and the body component is placed on top of the light strand. The body component is then secured in place on the corner via snapping the folded-over ends onto the edges of the corner. Once secure against the corner, the body component is held flush against the corner, securing the light strand between the exterior surface of the corner and the interior surface of the body component for use. In one embodiment, multiple holiday light strands can be positioned under the body component, with any suitable number of light strands being used, depending on the needs and/or wants of a user. In another embodiment, extension cords, cables, or satellite television cords, both single or multiple strands, can be secured under the body component and onto the corner, depending on the needs and/or wants of a user.

In one embodiment, the holiday light mount device is manufactured of plastic, such as vinyl or other suitable heat-sealable plastic or polymer materials, such as polypropylene, acrylonitrile-butadiene-styrene (ABS), or polyvinyl chloride (PVC), but may also be made of an alternative polymeric or plastic materials, or metals, etc., and may be used with vinyl siding, aluminum siding, or other suitable types of overlapping siding with corners. Additionally, the device is manufactured through common extruding and molding processes. Further, the holiday light mount device is also manufactured from a material that is water resistant or waterproof, or the body component comprises a coating that is water resistant or waterproof.

In one embodiment, the device can be molded in various colors and patterns to match existing décor and/or the existing color of the vinyl siding on the house or building being decorated, based upon a user's preference.

In one embodiment, multiple holiday light mount devices can be used together in series to support a strand or multiple strands of lights. Specifically, a holiday light mount device can be applied every few feet down a corner of a house to secure light strand(s) down an entire length of a house or building. Any suitable number of holiday light mount devices can be used at once, depending on the needs and/or wants of a user.

Further, the folded-over ends of the holiday light mount devices are readily insertable to the edge of the corners and do not require an additional tool for installation or removal. The ease of installation and/or removal of the holiday light mount device is facilitated by the engagement between the corner edge and the folded-over ends and the elasticity of the folded-over ends, which allow the folded-over ends to be pulled away and snapped over the corner edges without breaking, securing the device to the corner for use. Accordingly, objects, such as holiday light strands may be supported on vinyl siding corners without forming holes in the siding and/or without the need for adhesives.

In yet another embodiment, the holiday light mount device comprises a plurality of indicia.

In yet another embodiment, a method of securing holiday lights to a vinyl corner without nails or staples is disclosed. The method includes the steps of providing a holiday light mount device comprising a body component with opposing folded-over ends. The method also comprises positioning a strand of holiday lights under the body component on a vinyl corner to be decorated. Further, the method comprises securing the body component over the strand of holiday lights and onto the vinyl corner. The method also comprises snapping the body component onto the vinyl corner via the folded-over ends engaging the edges of the corner. Finally, the method comprises removing the body component after use, without damaging the vinyl corner.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the holiday light mount device of the present invention showing the device secured to a vinyl corner in accordance with the disclosed architecture;

FIG. 2 illustrates a perspective view of one embodiment of the holiday light mount device of the present invention showing the device securing a strand of lights in accordance with the disclosed architecture;

FIG. 3 illustrates a perspective view of one embodiment of the holiday light mount device of the present invention showing the device unattached to a corner in accordance with the disclosed architecture;

FIG. 4 illustrates a perspective view of one embodiment of the holiday light mount device of the present invention showing the device in use in accordance with the disclosed architecture; and

FIG. 5 illustrates a flowchart showing the method of securing holiday lights to a vinyl corner without nails or staples in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a holiday light mount device that provides users with a means for mounting exterior holiday lights to the vinyl corners of a home or building. There is also a long-felt need in the art for a holiday light mount device that enables users to secure the lights to the siding without the need for staples, hooks, nails, or other means. Further, there is a long-felt need in the art for a holiday light mount device that ensures that the lights can be installed and removed without damaging the vinyl siding. Moreover, there is a long-felt need in the art for a device that eases the task of decorating by making the process quick and frustration free. Further, there is a long-felt need in the art for a holiday light mount device that allows users to decorate areas that may conventionally be too difficult to access. Finally, there is a long-felt need in the art for a holiday light mount device that measures approximately one inch in width.

The present invention, in one exemplary embodiment, is a novel holiday light mount device. The holiday light mount device comprises a body component that is configured in an angled shape that mirrors the shape of the corner it is attached to. Typically, the body component is an elongated rectangular member that measures approximately one inch in width. The body component is secured around the corner and then snapped in place via its folded-over ends which engage the edges of the corner. The wire of the lights is positioned under the body component when the device is applied, securely holding the holiday lights in place. The present invention also includes a novel method of securing holiday lights to a vinyl corner without nails or staples. The method includes the steps of providing a holiday light mount device comprising a body component with opposing folded-over ends. The method also comprises positioning a strand of holiday lights under the body component on a vinyl corner to be decorated. Further, the method comprises securing the body component over the strand of holiday lights and onto the vinyl corner. The method also comprises snapping the body component onto the vinyl corner via the folded-over ends engaging the edges of the corner. Finally, the method comprises removing the body component after use, without damaging the vinyl corner.

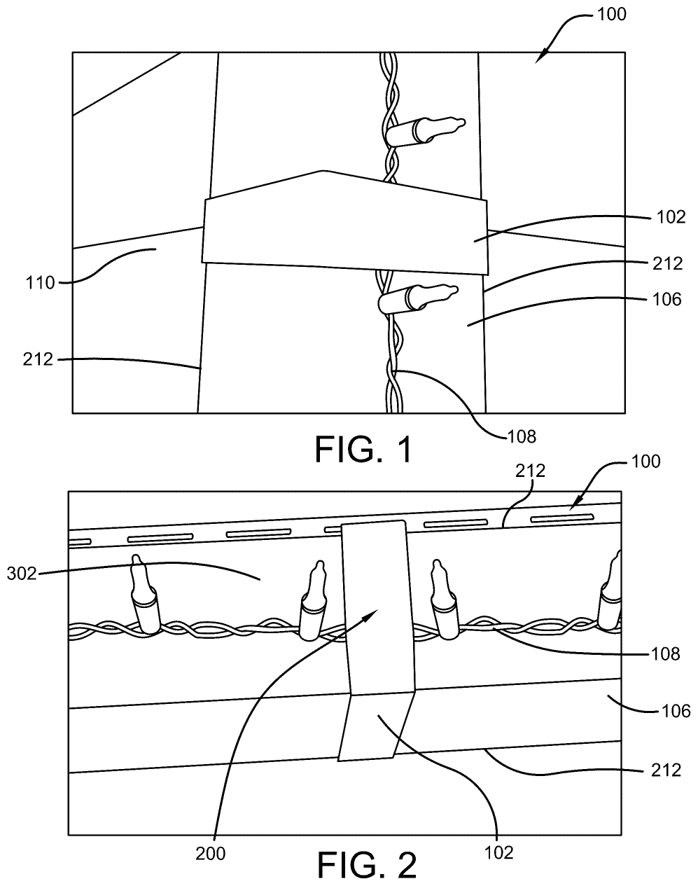

Referring initially to the drawings, FIG. 1 illustrates a perspective view of one embodiment of the holiday light mount device 100 of the present invention. In the present embodiment, the holiday light mount device 100 is an improved holiday light mount device 100 that provides a user with a means for mounting exterior holiday lights 108 to the vinyl corners 106 of a home or building 110. Specifically, the holiday light mount device 100 comprises a body component 102 with opposing folded-over ends 104 which engage the vinyl corner 106, securing the device 100 in place over a strand of holiday lights 108. The strand of lights 108 is positioned under the body component 102 when the device 100 is applied, securely holding the holiday lights 108 in place between the body component 102 and the corner 106.

Generally, the holiday light mount device 100 is a hanging mount positioned over the corners 106 that project outwards from a building or home 110, or from a support beam, etc., or any other suitable place as is known in the art. The holiday light mount device 100 may be used, for example, to mount objects such as Christmas lights 108, ornamental decorations, extension cords, cables or satellite television cords, etc., without damaging the vinyl siding. Notably, the holiday light mount device 100 is attached to and supported on vinyl corners 106 without requiring holes to be formed in or adhesives to be applied to the vinyl corners 106. As described in detail below, the holiday light mount device 100 is configured to be readily inserted over a strand of holiday lights 108 or other objects and onto the corner 106 of a building 110, mounting the holiday light strand 108 in place.

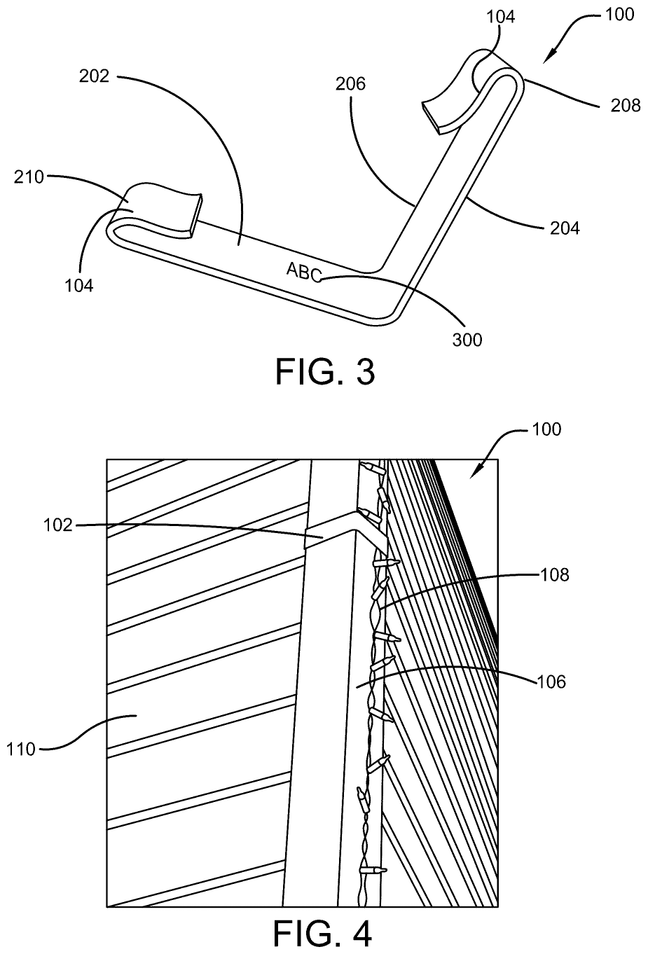

As shown in FIGS. 2-3, the holiday light mount device 100 comprises a body component 102 that is configured in an angled shape that mirrors the shape of the corner 106 it is attached to. Specifically, the body component 102 has an angled configuration that matches the angle of the outside corner 106 to which it is to be attached. Preferably, for a standard 90-degree outside corner 106, the body component 102 has an L-shaped configuration, with an angle of approximately ninety (90) degrees between the two sides of the L. However, if the outside corner 106 has an angle that is different than ninety (90) degrees, the body component 102 may be configured to match such an angle. The body component 102 can be any suitable size and shape as is known in the art, depending on the shape and size of the corner 106 it is to be attached to. Further, the body component 102 can be available in multiple sizes to be used with corners 106 of different sizes. Accordingly, the dimensions for the body component 102 may be selected such that the device 100 may be used with any siding corner 106 known in the art.

Furthermore, the body component 102 is an elongated, one-piece rectangular member that measures approximately one inch in width but can be any suitable size as is known in the art. The elongated rectangular member is typically configured in an L-shape or angled shape to mirror the corner 106. The body component 102 comprises an exterior surface 200 which faces out from the corner 106 and an interior surface 202 which faces toward the corner 106. The body component 102 also comprises top 204 and bottom 206 edges and opposing right 208 and left 210 ends.

Additionally, the opposing right 208 and left 210 ends of the body component 102 comprise folded-over ends 104, such that the opposing ends 208 and 210 fold-over on themselves. The folded-over ends 104 are elastic and ductile, such that the folded-over ends 104 retain their shape and are movable without breaking or fracturing. The folded-over ends 104 do not contact an interior surface 202 of the body component 102 but leave room between the ends 208 and 210 and the body component 102. Specifically, the opposing ends 208 and 210 extend outwardly from the body component 102 and fold-over on themselves, forming a curved lip or notch (i.e., folded-over ends 104). In use, the body component 102 is secured around the corner 106 and then snapped in place via its folded-over ends 104 which engage the edges 212 of the corner 106. The folded-over ends 104 secure to the corner 106 via an interference fit between the folded-over ends 104 and the edges 212 of the corner 106. After use, the device 100 can be easily removed via a user pulling open the folded-over ends 104, which releases the folded-over ends 104 from the edges 212 of the corner 106. Accordingly, the device 100 can be secured and removed from the corner 106 without use of nails, staples, or adhesives.

In one embodiment, the holiday light mount device 100 comprises a plurality of indicia 300. The body component 102 of the device 100 may include advertising, a trademark, or other letters, designs, or characters, printed, painted, stamped, or integrated into the body component 102, or any other indicia 300 as is known in the art. Specifically, any suitable indicia 300 as is known in the art can be included, such as, but not limited to, patterns, logos, emblems, images, symbols, designs, letters, words, characters, animals, advertisements, brands, etc., that may or may not be holiday lights, vinyl siding, or brand related.

Generally, the holiday light mount device 100 is manufactured of plastic, such as vinyl or other suitable heat-sealable plastic or polymer materials, such as polypropylene, acrylonitrile-butadiene-styrene (ABS), or polyvinyl chloride (PVC), but may also be made of an alternative polymeric or plastic materials, or metals, etc., and may be used with vinyl siding, aluminum siding, or other suitable types of overlapping siding with corners 106. Additionally, the device 100 is manufactured through common extruding and molding processes. Further, the holiday light mount device 100 is also manufactured from a material that is water resistant or waterproof, or the body component 102 comprises a coating that is water resistant or waterproof.

As shown in FIG. 4, the device 100 can be molded in various colors and patterns to match existing décor and/or the existing color of the vinyl siding on the house 110 or building being decorated, based upon a user's preference.

In one embodiment, multiple holiday light mount devices 100 can be used together in series to support a strand or multiple strands of lights 108. Specifically, a holiday light mount device 100 can be applied every few feet down a corner 106 of a house 110 to secure light strand(s) 108 down an entire length of a house 110 or building. Any suitable number of holiday light mount devices 100 can be used at once, depending on the needs and/or wants of a user.

In use, a single strand of holiday lights 108 is positioned on the exterior surface 302 of the corner 106 and the body component 102 is placed on top of the light strand 108. The body component 102 is then secured in place on the corner 106 via snapping the folded-over ends 104 onto the edges 212 of the corner 106. Once secure against the corner 106, the body component 102 is held flush against the corner 106, securing the light strand 108 between the exterior surface 302 of the corner 106 and the interior surface 202 of the body component 102 for use. In one embodiment, multiple holiday light strands 108 can be positioned under the body component 102, with any suitable number of light strands 108 being used, depending on the needs and/or wants of a user. In another embodiment, extension cords, cables, or satellite television cords, both single or multiple strands, can be secured under the body component 102 and onto the corner 106, depending on the needs and/or wants of a user.

Further, the folded-over ends 104 of the holiday light mount devices 100 are readily insertable to the edge 212 of the corners 106 and do not require an additional tool for installation or removal. The ease of installation and/or removal of the holiday light mount device 100 is facilitated by the engagement between the corner edge 212 and the folded-over ends 104 and the elasticity of the folded-over ends 104, which allow the folded-over ends 104 to be pulled away and snapped over the corner edges 212 without breaking, securing the device 100 to the corner 106 for use. Accordingly, objects, such as holiday light strands 108 may be supported on vinyl siding corners 106 without forming holes in the siding and/or without the need for adhesives.

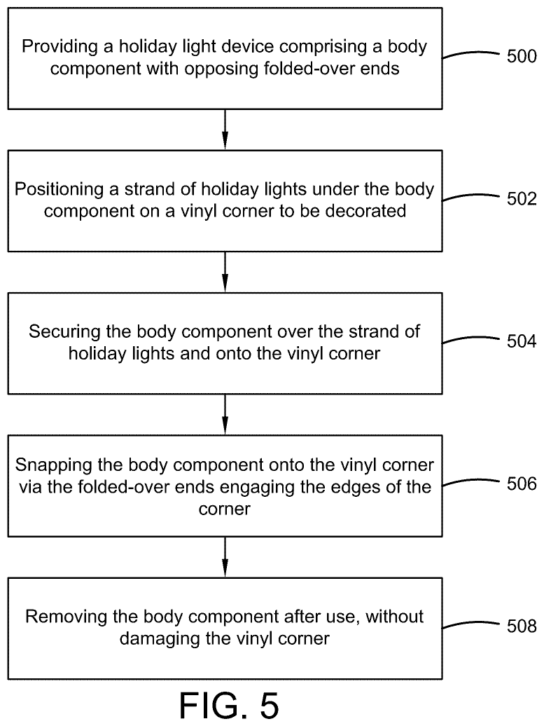

FIG. 5 illustrates a flowchart of the method of securing holiday lights to a vinyl corner without nails or staples. The method includes the steps of at 500, providing a holiday light mount device comprising a body component with opposing folded-over ends. The method also comprises at 502, positioning a strand of holiday lights under the body component on a vinyl corner to be decorated. Further, the method comprises at 504, securing the body component over the strand of holiday lights and onto the vinyl corner. The method also comprises at 506, snapping the body component onto the vinyl corner via the folded-over ends engaging the edges of the corner. Finally, the method comprises at 508, removing the body component after use, without damaging the vinyl corner.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “holiday light mount device”, “mount device”, “holiday light device”, and “device” are interchangeable and refer to the holiday light mount device 100 of the present invention.

Notwithstanding the foregoing, the holiday light mount device 100 of the present invention can be of any suitable size and configuration as is known in the art without affecting the overall concept of the invention, provided that it accomplishes the above-stated objectives. One of ordinary skill in the art will appreciate that the holiday light mount device 100 as shown in FIGS. 1-5 is for illustrative purposes only, and that many other sizes and shapes of the holiday light mount device 100 are well within the scope of the present disclosure. Although the dimensions of the holiday light mount device 100 are important design parameters for user convenience, the holiday light mount device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A holiday light mount device that provides a user with a means for mounting exterior holiday lights to vinyl corners of a home or building, the holiday light mount device comprising:
a body component; and
folded-over ends;
wherein at least one strand of holiday lights is positioned on a vinyl corner of a building and the body component is positioned overtop the at least one strand of holiday lights;
wherein the body component is then secured to the vinyl corner via the folded-over ends; and
further wherein the at least one strand of holiday lights is securely held in place between the body component and the vinyl corner.

2. The holiday light mount device of claim 1, wherein the vinyl corner is a corner that projects outwards from a building or home, or a support beam.

3. The holiday light mount device of claim 2, wherein the at least one strand of holiday lights comprises Christmas lights, ornamental decorations, extension cords, cables or satellite television cords.

4. The holiday light mount device of claim 3, wherein the body component is configured in an angled shape that mirrors a shape of the vinyl corner to which its attached.

5. The holiday light mount device of claim 4, wherein for a standard 90-degree outside vinyl corner, the body component has an L-shaped configuration, with an angle of approximately ninety (90) degrees between two sides of the L-shape.

6. The holiday light mount device of claim 5, wherein the body component is available in multiple sizes to be used with vinyl corners of different sizes.

7. The holiday light mount device of claim 6, wherein the body component is an elongated, one-piece rectangular member that measures approximately one inch in width.

8. The holiday light mount device of claim 7, wherein the body component comprises an exterior surface which faces out from the vinyl corner, an interior surface which faces toward the vinyl corner, top and bottom edges and opposing right and left ends.

9. The holiday light mount device of claim 8, wherein the opposing right and left ends of the body component comprise folded-over ends, such that the opposing right and left ends extend outwardly from the body component and fold-over on themselves forming a curved lip.

10. The holiday light mount device of claim 9, wherein the body component is secured around the vinyl corner and then snapped in place via the folded-over ends which engage edges of the vinyl corner via an interference fit.

11. The holiday light mount device of claim 10, wherein after use, the body component can be easily removed via a user pulling open the folded-over ends, which releases the folded-over ends from the edges of the vinyl corner.

12. A holiday light mount device that provides a user with a means for mounting exterior holiday lights to vinyl corners of a home or building, the holiday light mount device comprising:
a body component configured in an angled shape that mirrors a shape of the vinyl corner to which its attached; and
folded-over ends; and
wherein the body component is an elongated, one-piece rectangular member that measures approximately one inch in width;
wherein the body component comprises an exterior surface which faces out from the vinyl corner, an interior surface which faces toward the vinyl corner, top and bottom edges and opposing right and left ends;
wherein the opposing right and left ends of the body component comprise folded-over ends, such that the opposing right and left ends extend outwardly from the body component and fold-over on themselves forming a curved lip;
wherein at least one strand of holiday lights is positioned on a vinyl corner of a building and the body component is positioned overtop the at least one strand of holiday lights;
wherein the body component is secured around the vinyl corner and then snapped in place via the folded-over ends which engage edges of the vinyl corner via an interference fit; and
further wherein the at least one strand of holiday lights is securely held in place between the body component and the vinyl corner.

13. The holiday light mount device of claim 12, wherein after use, the body component can be easily removed via a user pulling open the folded-over ends, which releases the folded-over ends from the edges of the vinyl corner.

14. The holiday light mount device of claim 12 further comprising a plurality of indicia.

15. The holiday light mount device of claim 12, wherein the holiday light mount device is manufactured of a vinyl material.

16. The holiday light mount device of claim 12, wherein the holiday light mount device is also manufactured from a material that is water resistant or waterproof, or the body component comprises a coating that is water resistant or waterproof.

17. The holiday light mount device of claim 12, wherein the holiday light mount device can be molded in various colors and patterns to match existing décor or existing color of the vinyl corner.

18. The holiday light mount device of claim 12, wherein multiple holiday light mount devices can be used together in series to support a strand or multiple strands of holiday lights.

19. The holiday light mount device of claim 12, wherein a holiday light mount device is applied every few feet down a vinyl corner of a house to secure a strand or multiple strands of holiday lights down an entire length of a house or building.

20. A method of securing holiday lights to a vinyl corner without nails or staples, the method comprising the following steps:
providing a holiday light mount device comprising a body component with opposing folded-over ends;
positioning a strand of holiday lights under the body component on a vinyl corner to be decorated;
securing the body component over the strand of holiday lights and onto the vinyl corner;
snapping the body component onto the vinyl corner via the folded-over ends engaging the edges of the corner; and
removing the body component after use, without damaging the vinyl corner.
